(19) United States
(12) Patent Application Publication
(10) Pub. No.: US 2026/0067733 A1
(43) Pub. Date: Mar. 5, 2026

(54) REPORTING SPATIAL-DOMAIN CHANNEL PROPERTIES

(71) Applicant: Samsung Electronics Co., Ltd., Suwon-si (KR)

(72) Inventors: Gilwon Lee, Prosper, TX (US); Md. Saifur Rahman, Plano, TX (US); Eko Onggosanusi, Coppell, TX (US)

(21) Appl. No.: 19/296,865

(22) Filed: Aug. 11, 2025

Related U.S. Application Data
(60) Provisional application No. 63/690,723, filed on Sep. 4, 2024.

(51) Int. Cl. H04W 24/10; H04L 5/00

(52) U.S. Cl. CPC H04W 24/10; H04L 5/0057

(57) ABSTRACT

Apparatuses and methods for reporting spatial-domain channel properties. A method performed by a user equipment (UE) includes receiving information about a report associated with a channel state information (CSI) resource setting including a CSI reference-signal (CSI-RS) resource with P CSI-RS ports, a report quantity set to ‘sdcp’, and a reporting band and measuring the CSI-RS resource based on the information. The method further includes determining, based on the information, a correlation value between a first antenna port group and a second antenna port group and transmitting the report including the correlation value. The correlation value is normalized by at least one of norm values of the first antenna port group and second antenna port group over the reporting band. The first antenna port group corresponds to a first subset of the P CSI-RS ports. The second antenna port group corresponds to a second subset of the P CSI-RS ports.

### CROSS-REFERENCE TO RELATED AND CLAIM OF PRIORITY

The present application claims priority under 35 U.S.C. § 119 (e) to U.S. Provisional Patent Application No. 63/690,723 filed on Sep. 4, 2024, which is hereby incorporated by reference in its entirety.

### TECHNICAL FIELD

The present disclosure relates generally to wireless communication systems and, more specifically, the present disclosure is related to apparatuses and methods for reporting spatial-domain channel properties.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to reporting spatial-domain channel properties.

In one embodiment, a user equipment (UE) is provided. The UE includes a transceiver configured to receive information about a report associated with a channel state information (CSI) resource setting including a CSI reference-signal (CSI-RS) resource with P CSI-RS ports, a report quantity set to ‘sdcp’, and a reporting band. The UE further includes a processor operably coupled to the transceiver. The processor, based on the information, is configured to measure the CSI-RS resource and determine a correlation value between a first antenna port group and a second antenna port group. The correlation value is normalized by at least one of norm values of the first antenna port group and second antenna port group over the reporting band. The first antenna port group corresponds to a first subset of the P CSI-RS ports. The second antenna port group corresponds to a second subset of the P CSI-RS ports. The transceiver is further configured to transmit the report including the correlation value.

In another embodiment, a base station (BS) is provided. The BS includes a processor and a transceiver operably coupled to the processor. The transceiver is configured to transmit information about a report associated with a CSI resource setting including a CSI-RS resource with P CSI-RS ports, a report quantity set to ‘sdcp’, and a reporting band and receive the report including a correlation value between a first antenna port group and a second antenna port group. The correlation value is normalized by at least one of norm values of the first antenna port group and second antenna port group over the reporting band. The first antenna port group corresponds to a first subset of the P CSI-RS ports. The second antenna port group corresponds to a second subset of the P CSI-RS ports.

In yet another embodiment, a method performed by a UE is provided. The method includes receiving information about a report associated with a CSI resource setting including a CSI-RS resource with P CSI-RS ports, a report quantity set to ‘sdcp’, and a reporting band and measuring the CSI-RS resource based on the information. The method further includes determining, based on the information, a correlation value between a first antenna port group and a second antenna port group and transmitting the report including the correlation value. The correlation value is normalized by at least one of norm values of the first antenna port group and second antenna port group over the reporting band. The first antenna port group corresponds to a first subset of the P CSI-RS ports. The second antenna port group corresponds to a second subset of the P CSI-RS ports.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure;

FIG. 10 illustrates an example timeline for channel measurement/reporting according to embodiments of the present disclosure;

FIG. 11 illustrates an example antenna port layout according to embodiments of the present disclosure;

FIG. 12 illustrates an example 3D grid of discrete Fourier transform (DFT) beams according to embodiments of the present disclosure;

FIG. 13 illustrates an example of a timeline for a UE to receive nonzero power (NZP) channel state indication reference signal (CSI-RS) resource(s) bursts according to embodiments of the present disclosure;

FIG. 14 illustrates examples of timelines for partitioned CSI-RS burst instances according to embodiments of the present disclosure; and

FIG. 15 illustrates an example method performed by a UE in a wireless communication system according to embodiments of the present disclosure.

### DETAILED DESCRIPTION

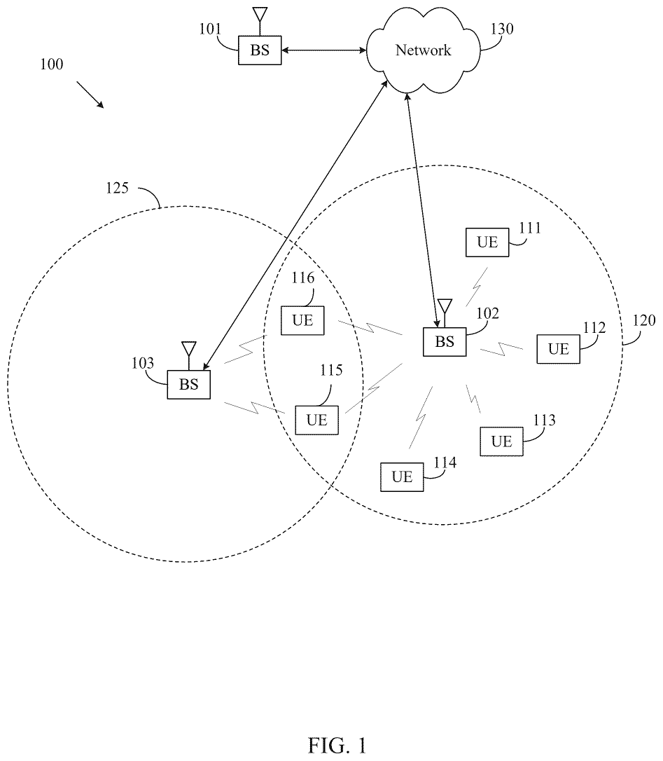

FIGS. 1-15 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 36.211 v18.0.1, “E-UTRA, Physical channels and modulation;” [REF 2] 3GPP TS 36.212 v18.0.0, “E-UTRA, Multiplexing and Channel coding;” [REF 3] 3GPP TS 36.213 v18.2.0, “E-UTRA, Physical Layer Procedures;” [REF 4] 3GPP TS 36.321 v18.2.0, “E-UTRA, Medium Access Control (MAC) protocol specification;” [REF 5] 3GPP TS 36.331 v18.2.0, “E-UTRA, Radio Resource Control (RRC) Protocol Specification;” [REF 6] 3GPP TR 22.891 v1.2.0; [REF 7] 3GPP TS 38.212 v18.2.0, “E-UTRA, NR, Multiplexing and Channel coding;” [REF 8] 3GPP TS 38.214 v18.2.0, “E-UTRA, NR, Physical layer procedures for data;” [REF 9] RP-192978, “Measurement results on Doppler spectrum for various UE mobility environments and related CSI enhancements,” Fraunhofer IIS, Fraunhofer HHI, Deutsche Telekom; and [REF 10] 3GPP TS 38.211 v18.2.0, “E-UTRA, NR, Physical channels and modulation.”

FIGS. 1-14 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for reporting spatial-domain channel properties. In certain embodiments, one or more of the BSs 101-103 include circuitry, programing, or a combination thereof to support reporting spatial-domain channel properties.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

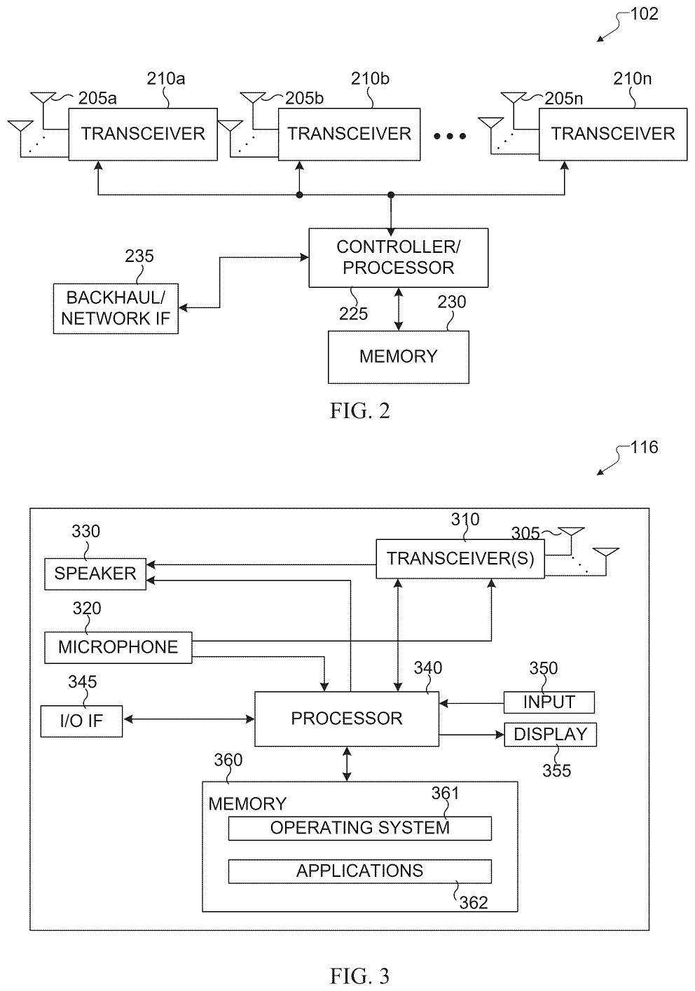

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for reporting spatial-domain channel properties. Any of a wide variety of other functions could be supported in the gNB 102 by the controller/processor 225.

The controller/processor 225 is also capable of executing programs and other processes resident in the memory 230, such as processes to support reporting spatial-domain channel properties. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for reporting spatial-domain channel properties as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUS). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

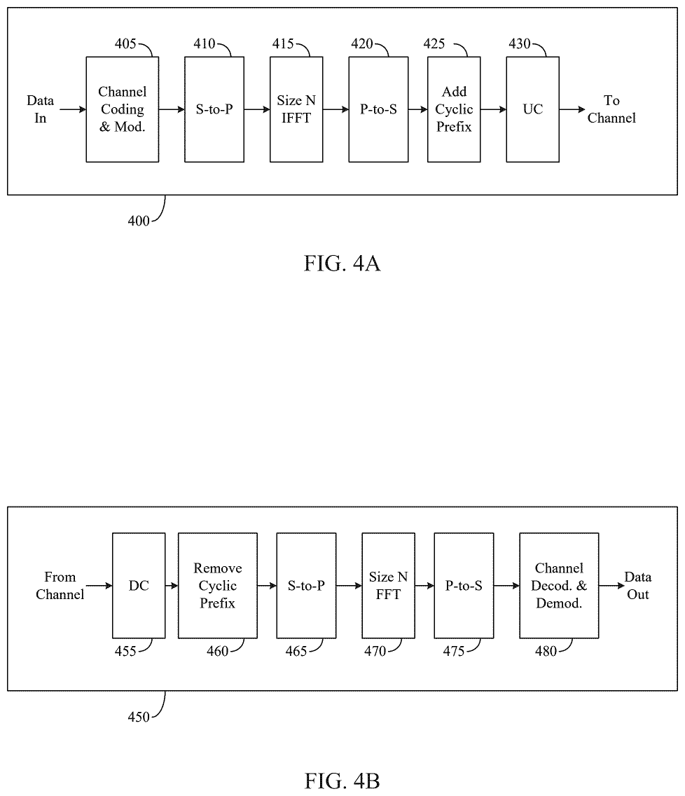

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for reporting spatial-domain channel properties as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

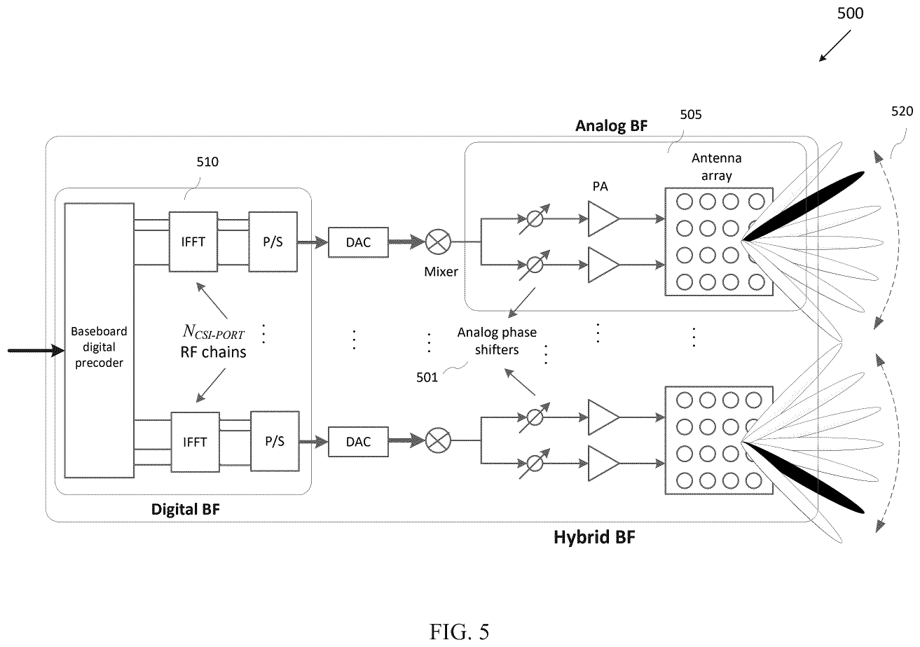

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NeSI-PORT. A digital beamforming unit 510 performs a linear combination across NeSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

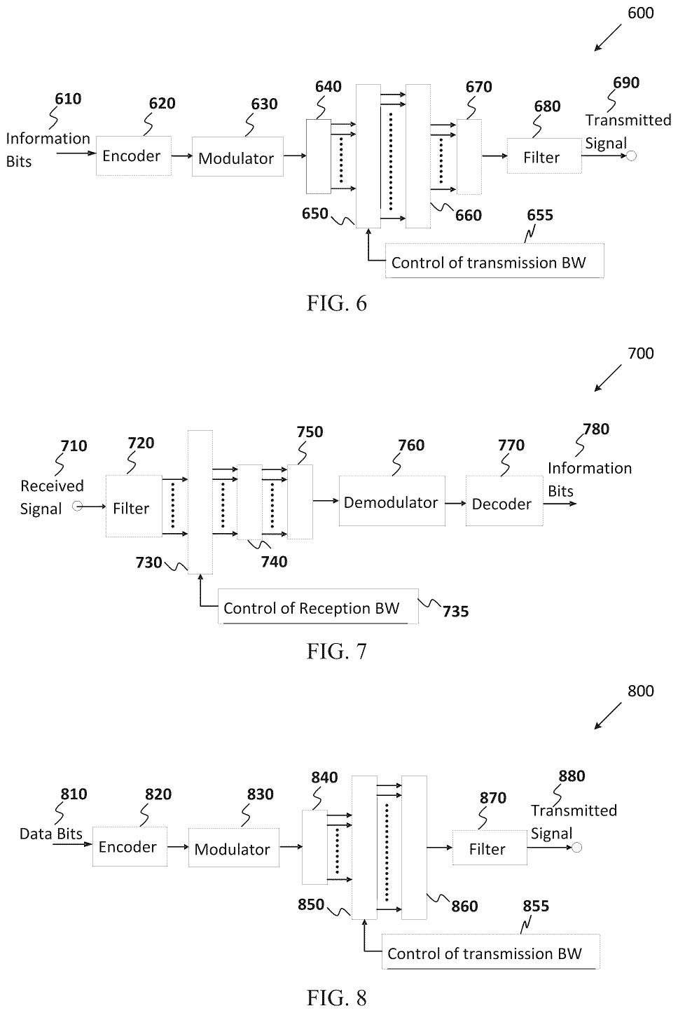

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a demodulation reference signal (DMRS) or a CRS (not shown), and a decoder 770, such as a turbo decoder, decodes the demodulated data to provide an estimate of the information data bits 780. Additional functionalities such as time-windowing, cyclic prefix removal, de-scrambling, channel estimation, and de-interleaving are not shown for brevity.

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

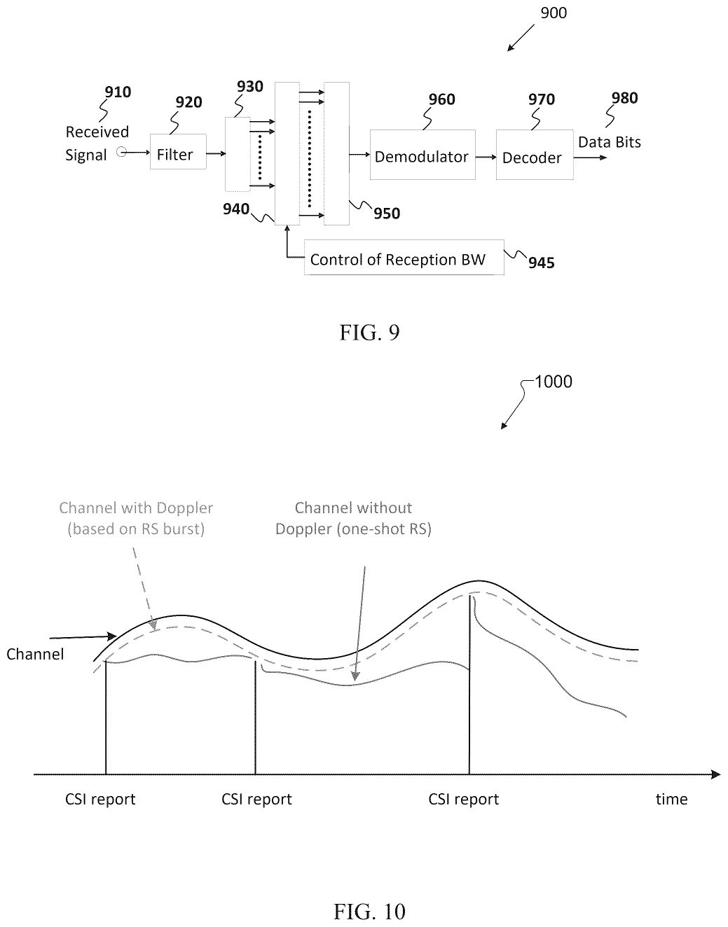

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies a FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DMRS (not shown), a decoder 970, such as a turbo decoder, decodes the demodulated data to provide an estimate of the information data bits 980.

The present disclosure relates generally to wireless communication systems and, more specifically, to reporting of spatial-domain channel properties.

A communication system includes a DownLink (DL) that conveys signals from transmission points such as Base Stations (BSs) or NodeBs to User Equipments (UEs) and an UpLink (UL) that conveys signals from UEs to reception points such as NodeBs. A UE, also commonly referred to as a terminal or a mobile station, may be fixed or mobile and may be a cellular phone, a personal computer device, or an automated device. An eNodeB, which is generally a fixed station, may also be referred to as an access point or other equivalent terminology. For LTE systems, a NodeB is often referred as an eNodeB.

In a communication system, such as LTE, DL signals can include data signals conveying information content, control signals conveying DL Control Information (DCI), and Reference Signals (RS) that are also known as pilot signals. An eNodeB transmits data information through a Physical DL Shared CHannel (PDSCH). An eNodeB transmits DCI through a Physical DL Control CHannel (PDCCH) or an Enhanced PDCCH (EPDCCH)—see also REF 3. An eNodeB transmits acknowledgement information in response to data Transport Block (TB) transmission from a UE in a Physical Hybrid ARQ Indicator CHannel (PHICH). An eNodeB transmits one or more of multiple types of RS including a UE-Common RS (CRS), a Channel State Information RS (CSI-RS), or a DeModulation RS (DMRS). A CRS is transmitted over a DL system BandWidth (BW) and can be used by UEs to obtain a channel estimate to demodulate data or control information or to perform measurements. To reduce CRS overhead, an eNodeB may transmit a CSI-RS with a smaller density in the time and/or frequency domain than a CRS. DMRS can be transmitted only in the BW of a respective PDSCH or EPDCCH and a UE can use the DMRS to demodulate data or control information in a PDSCH or an EPDCCH, respectively. A transmission time interval for DL channels is referred to as a subframe (or slot) and can have, for example, duration of 1 millisecond.

DL signals also include transmission of a logical channel that carries system control information. A broadcast control channel (BCCH) is mapped to either a transport channel referred to as a Broadcast CHannel (BCH) when it conveys a Master Information Block (MIB) or to a DL Shared CHannel (DL-SCH) when it conveys a System Information Block (SIB)—see also REF3 and REF 5. Most system information is included in different SIBs that are transmitted using DL-SCH. A presence of system information on a DL-SCH in a subframe (or slot) can be indicated by a transmission of a corresponding PDCCH conveying a codeword with a cyclic redundancy check (CRC) scrambled with a special System Information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe (or slot) and a group of Physical resource blocks (PRBs). A transmission BW includes frequency resource units referred to as Resource Blocks (RBs). Each RB includes

$${N}_{sc}^{RB}$$

sub-carriers, or Kesource Elements (REs), such as 12 REs. A unit of one RB over one subframe (or slot) is referred to as a PRB. A UE can be allocated M_{PDSCH} RBs for a total of

$${M}_{sc}^{PDSCH} = {M}_{PDSCH} \cdot {N}_{sc}^{RB}$$

REs for the PDSCH transmission BW.

UL signals can include data signals conveying data information, control signals conveying UL Control Information (UCI), and UL RS. UL RS includes DMRS and Sounding RS (SRS). A UE transmits DMRS only in a BW of a respective PUSCH or PUCCH. An eNodeB can use a DMRS to demodulate data signals or UCI signals. A UE transmits SRS to provide an eNodeB with an UL CSI. A UE transmits data information or UCI through a respective Physical UL Shared CHannel (PUSCH) or a Physical UL Control CHannel (PUCCH). If a UE needs to transmit data information and UCI in a same UL subframe (or slot), it may multiplex both in a PUSCH. UCI includes Hybrid Automatic Repeat reQuest ACKnowledgement (HARQ-ACK) information, indicating correct (ACK) or incorrect (NACK) detection for a data TB in a PDSCH or absence of a PDCCH detection (DTX), Scheduling Request (SR) indicating whether a UE has data in its buffer, Rank Indicator (RI), and Channel State Information (CSI) enabling an eNodeB to perform link adaptation for PDSCH transmissions to a UE. HARQ-ACK information is also transmitted by a UE in response to a detection of a PDCCH/EPDCCH indicating a release of semi-persistently scheduled PDSCH (see also REF 3).

An UL subframe (or slot) includes two slots. Each slot includes

$${N}_{s y m b}^{UL}$$

symbols for transmitting data information, UCI, DMRS, or SRS. A frequency resource unit of an UL system BW is a RB. A UE is allocated N_{RB} RBs for a total of

$${N}_{R B} \cdot {N}_{s c}^{R B}$$

REs for a transmission BW. For a PUCCH, N_{RB}=1. A last subframe (or slot) symbol can be used to multiplex SRS transmissions from one or more UEs. A number of subframe (or slot) symbols that are available for data/UCI/DMRS transmission is

$${N}_{symb} = 2 \cdot ( {N}_{symb}^{UL} - 1 ) - {N}_{S R S} , where {N}_{RS} = 1$$

if a last subframe (or slot) symbol is used to transmit SRS and N_{SRS}=0 otherwise.

In scenarios where DL long-term channel statistics can be measured through UL signals at a serving eNodeB, UE-specific beamforming (BF) CSI-RS can be readily used. This is typically feasible when UL-DL duplex distance is sufficiently small. When this condition does not hold, however, some UE feedback is necessary for the eNodeB to obtain an estimate of DL long-term channel statistics (or any of its representation thereof). To facilitate such a procedure, a first BF CSI-RS transmitted with periodicity T1 (ms) and a second NP CSI-RS transmitted with periodicity T2 (ms), where T1≤T2. This approach is termed hybrid CSI-RS. The implementation of hybrid CSI-RS is largely dependent on the definition of CSI process and NZP CSI-RS resource.

In a wireless communication system, MIMO is often identified as an essential feature in order to achieve high system throughput requirements. One of the key components of a MIMO transmission scheme is the accurate CSI acquisition at the eNB (or gNB) (or TRP). For MU-MIMO, in particular, the availability of accurate CSI is necessary in order to guarantee high MU performance. For TDD systems, the CSI can be acquired using the SRS transmission relying on the channel reciprocity. For frequency division duplexing (FDD) systems, on the other hand, it can be acquired using the CSI-RS transmission from eNB (or gNB), and CSI acquisition and feedback from UE. In FDD systems, the CSI feedback framework is ‘implicit’ in the form of channel quality indicator (CQI)/precoding matrix indicator (PMI)/rank indicator (RI) (also CQI report interval (CRI) and layer index (LI)) derived from a codebook assuming SU transmission from eNB (or gNB).

In 5G or NR systems [REF7, REF8], the “implicit” CSI reporting paradigm from LTE mentioned herein is also supported and referred to as Type I CSI reporting. In addition, a high-resolution CSI reporting, referred to as Type II CSI reporting, is also supported to provide more accurate CSI information to gNB for use cases such as high-order MU-MIMO. However, the overhead of Type II CSI reporting can be an issue in practical UE implementations. One approach to reduce Type II CSI overhead is based on frequency domain (FD) compression. In Rel. 16 NR, DFT-based FD compression of the Type II CSI has been supported (referred to as Rel. 16 enhanced Type II codebook in REF8). Some of the key components for this feature includes (a) spatial domain (SD) basis W₁, (b) FD basis W_{f}, and (c) coefficients \tilde{W}₂ that linearly combine SD and FD basis. In a non-reciprocal FDD system, a complete CSI (comprising each component) needs to be reported by the UE. However, when reciprocity or partial reciprocity does exist between UL and DL, then some of the CSI components can be obtained based on the UL channel estimated using SRS transmission from the UE. In Rel. 16 NR, the DFT-based FD compression is extended to this partial reciprocity case (referred to as Rel. 16 enhanced Type II port selection codebook in REF8), wherein the DFT-based SD basis in W₁ is replaced with SD CSI-RS port selection, i.e., L out of

$$\frac{{P}_{CSI - RS}}{2}$$

CSI-KS ports are selected (the selection is common for the two antenna polarizations or two halves of the CSI-RS ports). The CSI-RS ports in this case are beamformed in SD (assuming UL-DL channel reciprocity in angular domain), and the beamforming information can be obtained at the gNB based on UL channel estimated using SRS measurements.

It has been known in the literature that UL-DL channel reciprocity can exist in both angular and delay domains if the UL-DL duplexing distance is small. Since delay in time domain transforms (or closely related to) basis vectors in frequency domain (FD), the Rel. 16 enhanced Type II port selection can be further extended to both angular and delay domains (or SD and FD). In particular, the DFT-based SD basis in W₁ and DFT-based FD basis in We can be replaced with SD and FD port selection, i.e., L CSI-RS ports are selected in SD or/and M ports are selected in FD. The CSI-RS ports in this case are beamformed in SD (assuming UL-DL channel reciprocity in angular domain) or/and FD (assuming UL-DL channel reciprocity in delay/frequency domain), and the corresponding SD or/and FD beamforming information can be obtained at the gNB (e.g., the BS 102) based on UL channel estimated using SRS measurements. In Rel. 17, such a codebook is supported (which is referred to as Rel. 17 further enhanced Type II port selection codebook in REF8).

FIG. 10 illustrates an example timeline 1000 for channel measurement/reporting according to embodiments of the present disclosure. For example, timeline 1000 can be followed by any of the UEs 111-116 of FIG. 1. This example is for illustration only and other embodiments can be used without departing from the scope of the present disclosure.

Now, when the UE speed is in a moderate or high speed regime, the performance of the Rel. 15/16/17 codebooks starts to deteriorate quickly due to fast channel variations (which in turn is due to UE mobility that contributes to the Doppler component of the channel), and a one-shot nature of CSI-RS measurement and CSI reporting in Rel. 15/16/17. This limits the usefulness of Rel. 15/16/17 codebooks to low mobility or static UEs only. For moderate or high mobility scenarios, an enhancement in CSI-RS measurement and CSI reporting is needed, which is based on the time-domain (TD) variations or Doppler components of the channel. As described in [REF9], the Doppler components of the channel remain almost constant over a large time duration, referred to as channel stationarity time, which is significantly larger than the channel coherence time. Note that the current (Rel. 15/16/17) CSI reporting is based on the channel coherence time, which is not suitable when the channel has significant Doppler components. The Doppler components of the channel can be calculated based on measuring a reference signal (RS) burst, where the RS can be CSI-RS or SRS. When RS is CSI-RS, the UE measures a CSI-RS burst and use it to obtain Doppler components of the DL channel, and when RS is SRS, the gNB measures an SRS burst, and use it to obtain Doppler components of the UL channel. The obtained Doppler components can be reported by the UE using a codebook (as part of a CS report). Or the gNB can use the obtained Doppler components of the UL channel to beamform CSI-RS for CSI reporting by the UE. An illustration of channel measurement with and without Doppler components is shown in FIG. 10. When the channel is measured with the Doppler components (e.g. based on an RS burst), the measured channel can remain close to the actual varying channel. On the other hand, when the channel is measured without the Doppler components (e.g. based on a one-shot RS), the measured channel can be far from the actual varying channel.

Embodiments of the present disclosure recognize that measuring an RS burst is needed in order to obtain the Doppler components of the channel. This disclosure provides several example embodiments on measuring an RS burst (measuring time varying channel over a measurement window) and reporting of TD channel properties (such as Doppler components of the channel).

The present disclosure relates to acquisition of spatial-domain channel properties (SDCP) at gNB. In particular, it relates to the reporting SDCP. Provided aspects are as follows:
Channel measurement resources for SDCP
Signaling/configuration details of SDCP reporting
Examples of SDCP reporting (content, alphabet set etc.)

In the following, for brevity, both FDD and TDD are regarded as the duplex method for both DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure covers several components which can be used in conjunction or in combination with one another, or can operate as standalone schemes.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, the following components and embodiments are applicable for UL transmission when the scheduling unit in time is either one subframe (which can include one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” or bandwidth part (BWP) can also be used.

In terms of UE configuration, a UE (e.g., the UE 116) can be configured with at least one CSI reporting band. This configuration can be semi-static (via higher-layer signaling or RRC) or dynamic (via MAC CE or L1 DL control signaling). When configured with multiple (N) CSI reporting bands (e.g. via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for the Mn subbands within the CSI reporting band. A CSI parameter is configured with “subband” for the CSI reporting band with Mn subbands when one CSI parameter is reported for each of the Mn subbands within the CSI reporting band.

FIG. 11 illustrates an example antenna port layout 1100 according to embodiments of the present disclosure. For example, antenna port layout 1100 can be implemented in any of the UEs 111-116 of FIG. 1, such as the UE 111. This example is for illustration only and other embodiments can be used without departing from the scope of the present disclosure.

In the following, N₁ and N₂ are the number of antenna ports with the same polarization in the first and second dimensions, respectively. For 2D antenna port layouts, N₁>1, N₂>1, and for 1D antenna port layouts N₁>1 and N₂=1. So, for a dual-polarized antenna port layout, the total number of antenna ports is 2N₁N₂ when each antenna maps to an antenna port. An illustration is shown in FIG. 11 where “X” represents two antenna polarizations. In this disclosure, the term “polarization” refers to a group of antenna ports. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g. X=3000, then antenna ports are 3000, 3001, 3002, . . . ).

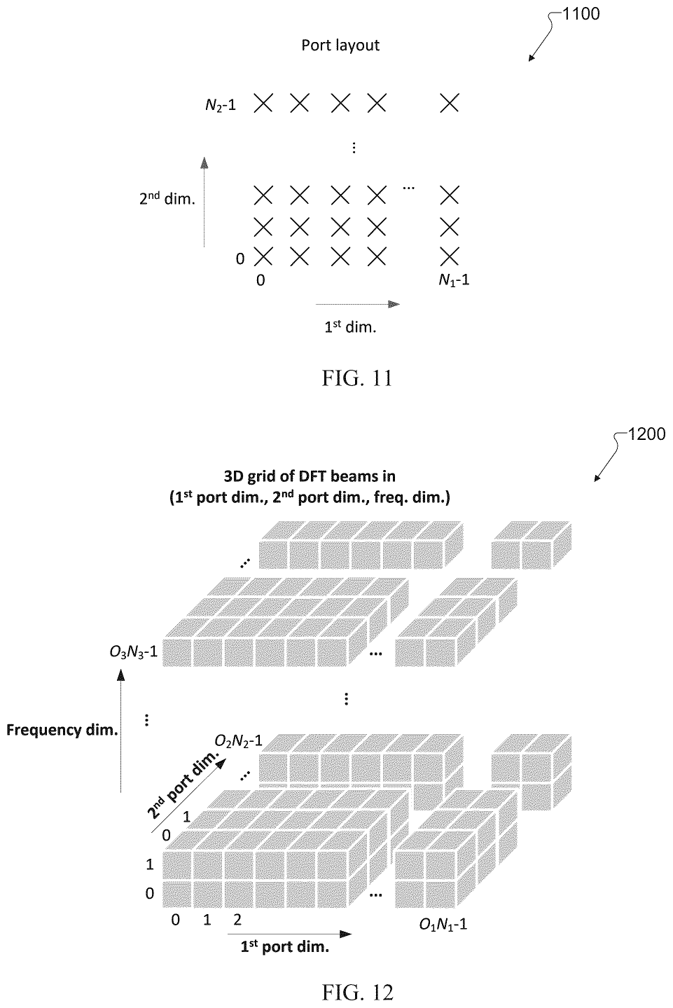

FIG. 12 illustrates an example 3D grid 1200 of DFT beams according to embodiments of the present disclosure. For example, 3D grid 1200 of DFT beams can be utilized by any of the UEs 111-116 of FIG. 1, such as the UE 112. This example is for illustration only and other embodiments can be used without departing from the scope of the present disclosure.

As described in U.S. Pat. No. 10,659,118 granted May 19, 2020, which is incorporated herein by reference in its entirety, a UE is configured with high-resolution (e.g. Type II) CSI reporting in which the linear combination based Type II CSI reporting framework is extended to include frequency dimension in addition to the 1st and 2nd antenna port dimensions. An illustration of the 3D grid of the oversampled DFT beams (1st port dim., 2nd port dim., freq. dim.) is shown in FIG. 12 in which
1st dimension is associated with the 1st port dimension,
2nd dimension is associated with the 2nd port dimension, and
3rd dimension is associated with the frequency dimension.

The basis sets for 1^{st} and 2^{nd} port domain representation are oversampled DFT codebooks of length-N₁ and length-N₂, respectively, and with oversampling factors O₁ and O₂, respectively. Likewise, the basis set for frequency domain representation (i.e., 3rd dimension) is an oversampled DFT codebook of length-N₃ and with oversampling factor O₃. In one example, O₁=O₂=O₃=4. In one example, O₁=O₂=4 and O₃=1. In another example, the oversampling factors Oᵢ belongs to {2, 4, 8}. In yet another example, at least one of O₁, O₂, and O₃ is higher layer configured (via RRC signaling).

As explained in Section 5.2.2.2.6 of REF8, a UE is configured with higher layer parameter codebookType set to ‘typeII-PortSelection-r16’ for an enhanced Type II CSI reporting in which the pre-coders for SBs and for a given layer l=1, . . . , v, where v is the associated RI value, is given by either

$${W}^{l} = A {C}_{l} {B}^{H} = [ \begin{matrix}{a}_{0} & {a}_{1} & … & {a}_{L - 1}\end{matrix} ] [ \begin{matrix}{c}_{l , 0 , 0} & {c}_{l , 0 , 1} & … & {c}_{l , 0 , M - 1} \\ {c}_{l , 1 , 0} & {c}_{l , 1 , 1} & … & {c}_{l , 1 , M - 1} \\ ⋮ & ⋮ & ⋮ & ⋮ \\ {c}_{l , L - 1 , 0} & {c}_{l , L - 1 , 1} & … & {c}_{l , L - 1 , M - 1}\end{matrix} ] \\ {[ \begin{matrix}{b}_{0} & {b}_{1} & … & {b}_{M - 1}\end{matrix} ]}^{H} = {\sum }_{f = 0}^{M - 1} {\sum }_{i = 0}^{L - 1} {c}_{l , i , f} ( {a}_{i} {b}_{f}^{H} ) = {\sum }_{i = 0}^{L - 1} {\sum }_{f = 0}^{M - 1} {c}_{l , i , f} ( {a}_{i} {b}_{f}^{H} ) , \qquad ( Eq . 1 )$$

$$or$$

$${W}^{l} = [ \begin{matrix}A & 0 \\ 0 & A\end{matrix} ] {C}_{l} {B}^{H} = [ \begin{matrix}{a}_{0} {a}_{1} … {a}_{L - 1} & 0 \\ 0 & {a}_{0} {a}_{1} … {a}_{L - 1}\end{matrix} ] {[ \begin{matrix}{c}_{l , 0 , 0} & {c}_{l , 0 , 1} & … & {c}_{l , 0 , M - 1} \\ {c}_{l , 1 , 0} & {c}_{l , 1 , 1} & … & {c}_{l , 1 , M - 1} \\ ⋮ & ⋮ & ⋮ & ⋮ \\ {c}_{l , L - 1 , 0} & {c}_{l , L - 1 , 1} & … & {c}_{l , L - 1 , M - 1}\end{matrix} ] [ \begin{matrix}{b}_{0} & {b}_{1} & … & {b}_{M - 1}\end{matrix} ]}^{H} = [ \begin{matrix}{\sum }_{f = 0}^{M - 1} {\sum }_{i = 0}^{L - 1} {c}_{l , i , f} ( {a}_{i} {b}_{f}^{H} ) \\ {\sum }_{f = 0}^{M - 1} {\sum }_{i = 0}^{L - 1} {c}_{l , i + L , f} ( {a}_{i} {b}_{f}^{H} )\end{matrix} ] , \qquad ( Eq . 2 )$$

where
N₁ is a number of antenna ports in a first antenna port dimension (having the same antenna polarization),
N₂ is a number of antenna ports in a second antenna port dimension (having the same antenna polarization),
P_{CSI-RS} is a number of CSI-RS ports configured to the UE,
N₃ is a number of SBs for PMI reporting or number of FD units or number of FD components (that comprise the CSI reporting band) or a total number of precoding matrices indicated by the PMI (one for each FD unit/component),

$${a}_{i} is a 2 {N}_{1} {N}_{2} \times 1 ( Eq . 1 ) or {N}_{1} {N}_{2} \times 1 ( Eq . 2 ) column vector ,$$

$$or {a}_{i} is a {P}_{CSIRS} \times 1 ( Eq . 1 ) or \frac{{P}_{CSIRS}}{2} \times 1$$

port selection column vector, where a port selection vector is a defined as a vector which contains a value of 1 in one element and zeros elsewhere
b_{f} is a N₃×1 column vector,
c_{l,i,f} is a complex coefficient.

In a variation, when the UE reports a subset K<2 LM coefficients (where K is either fixed, configured by the gNB or reported by the UE), then the coefficient c_{l,i,f} in precoder equations Eq. 1 or Eq. 2 is replaced with x_{l,i,f}×c_{l,i,f}, where.
x_{l,i,f}=1 if the coefficient c_{l,i,f} is reported by the UE according to some embodiments of this disclosure.
x_{l,i,f}=0 otherwise (i.e., c_{l,i,f} is not reported by the UE).

The indication whether x_{l,i,f}=1 or 0 is according to some embodiments of this disclosure. For example, it can be via a bitmap.

In a variation, the precoder equations Eq. 1 or Eq. 2 are respectively generalized to

$${W}^{l} = {\sum }_{i = 0}^{L - 1} {\sum }_{f = 0}^{{M}_{i} - 1} {c}_{l , i , f} ( {a}_{i} {b}_{i , f}^{H} ) \qquad ( Eq . 3 )$$

$$and$$

$${W}^{l} = [ \begin{matrix}{\sum }_{i = 0}^{L - 1} {\sum }_{f = 0}^{{M}_{i} - 1} {c}_{l , i , f} ( {a}_{i} {b}_{i , f}^{H} ) \\ {\sum }_{i = 0}^{L - 1} {\sum }_{= 0}^{{M}_{i} - 1} {c}_{l , i + L , f} ( {a}_{i} {b}_{i , f}^{H} )\end{matrix} ] , \qquad ( Eq . 4 )$$

where for a given i, the number of basis vectors is Mᵢ and the corresponding basis vectors are {b_{i,f}}. Note that Mᵢ is the number of coefficients c_{l,i,f} reported by the UE for a given i, where Mᵢ≤M (where {Mᵢ} or ΣMᵢ is either fixed, configured by the gNB or reported by the UE).

The columns of W^{l} are normalized to norm one. For rank R or R layers (v=R), the precoding matrix is given by

$${W}^{( R )} = \frac{1}{\sqrt{R}} [ \begin{matrix}{W}^{1} & {W}^{2} & … & {W}^{R}\end{matrix} ] .$$

Eq. 2 is assumed in the rest of the disclosure. The embodiments of the disclosure, however, are general and are also application to Eq. 1, Eq. 3 and Eq. 4.

Here

$$L \leq \frac{{P}_{CSI - RS}}{2} and M \leq {N}_{3} . If L = \frac{{P}_{CSI - RS}}{2} ,$$

then A is an identity matrix, and hence not reported. Likewise, if M=N₃, then B is an identity matrix, and hence not reported. Expecting M<N₃, in an example, to report columns of B, the oversampled DFT codebook is used. For instance, b_{f}=W_{f}, where the quantity w_{f} is given by

$${w}_{f} = {[ \begin{matrix}1 & {e}^{j \frac{2 π {n}_{3 , l}^{( f )}}{{O}_{3} {N}_{3}}} & {e}^{j \frac{2 π \text{.2} {n}_{3 , l}^{( f )}}{{O}_{3} {N}_{3}}} & … & {e}^{j \frac{2 π . ( {N}_{3} - 1 ) {n}_{3 , l}^{( f )}}{{O}_{3} {N}_{3}}}\end{matrix} ]}^{T} .$$

When O₃=1, the FD basis vector for layer l∈{1, . . . , υ} (where υ is the RI or rank value) is given by

$${w}_{f} = {[ \begin{matrix}{y}_{0 , l}^{( f )} & {y}_{1 , l}^{( f )} & … & {y}_{{N}_{3} - 1 , l}^{( f )}\end{matrix} ]}^{T} ,$$

$$where {y}_{t , l}^{( f )} = {e}^{j \frac{2 π t {n}_{3 , l}^{( f )}}{{N}_{3}}} and {n}_{3 , l} = [ {n}_{3 , l}^{( 0 )} , … , {n}_{3 , l}^{( M - 1 )} ] where$$

$${n}_{3 , l}^{( f )} ∈ \{ 0 , 1 , … , {N}_{3} - 1 \} .$$

In another example, discrete cosine transform DCT basis is used to construct/report basis B for the 3^{rd} dimension. The m-th column of the DCT compression matrix is simply given by

$${[ {W}_{f} ]}_{n m} = \{ \begin{matrix}\frac{1}{\sqrt{2}} , n = 0 \\ \sqrt{\frac{2}{K}} cos \frac{π ( 2 m + 1 ) n}{2 K} , n = 1 , … K - 1\end{matrix} ,$$

$$and K = {N}_{3} , and m = 0 , … , {N}_{3} - 1.$$

Since DCT is applied to real valued coefficients, the DCT is applied to the real and imaginary components (of the channel or channel eigenvectors) separately. Alternatively, the DCT is applied to the magnitude and phase components (of the channel or channel eigenvectors) separately. The use of DFT or DCT basis is for illustration purpose only. The disclosure is applicable to any other basis vectors to construct/report A and B.

On a high level, a precoder W^{l} can be described as follows.

$$W = {A}_{l} {C}_{l} {B}_{l}^{H} = {W}_{1} {\tilde{W}}_{2} {W}_{f}^{H} , \qquad ( 5 )$$

where A=W₁ corresponds to the Rel. 15 W₁ in Type II CSI codebook [REF8], and B=W_{f}.

The Cₗ=\tilde{W}₂ matrix includes the required linear combination coefficients (e.g. amplitude and phase or real or imaginary). Each reported coefficient (c_{l,i,f}=P_{l,i,f}φ_{l,i,f}) in \tilde{W}₂ is quantized as amplitude coefficient (p_{l,i,f}) and phase coefficient (p_{l,i,f}). In one example, the amplitude coefficient (p_{l,i,f}) is reported using a A-bit amplitude codebook where A belongs to {2, 3, 4}. If multiple values for A are supported, then one value is configured via higher layer signaling.

In another example, the amplitude coefficient (p_{l,i,f}) is reported as

$${p}_{l , i , f} = {p}_{l , i , f}^{( 1 )} {p}_{l , i , f}^{( 2 )}$$

where

$${p}_{l , i , f}^{( 1 )}$$

is a reference or first amplitude which is reported using a A1-bit amplitude codebook where A1 belongs to {2, 3, 4}, and

$${p}_{l , i , f}^{( 2 )}$$

is a differential or second amplitude which is reported using a A2-bit amplitude codebook where A2≤A1 belongs to {2, 3, 4}.

For layer l, the linear combination (LC) coefficient associated with spatial domain (SD) basis vector (or beam) is denoted i∈{0, 1, . . . , 2L−1} and frequency domain (FD) basis vector (or beam) f∈{0, 1, . . . , M−1} is denoted as c_{l,i,f}, and the strongest coefficient as c_{l,i,f}*. The strongest coefficient is reported out of the K_{NZ} non-zero (NZ) coefficients that is reported using a bitmap, where K_{NZ}≤K₀=┌B×2LM┐<2 LM and β is higher layer configured. The remaining 2 LM−K_{NZ} coefficients that are not reported by the UE are assumed to be zero. The following quantization scheme is used to quantize/report the K_{NZ} NZ coefficients.
UE reports the following for the quantization of the NZ coefficients in \tilde{W}₂
   A X-bit indicator for the strongest coefficient index (i*, f*), where X=┌log₂ K_{Nz}┐ or ┌log₂ 2L┐.
      Strongest coefficient c_{l,i*,f*}=1 (hence its amplitude/phase are not reported)
   Two antenna polarization-specific reference amplitudes is used.
      For the polarization associated with the strongest coefficient c_{l,i*,f*}=1, since the reference amplitude

$${p}_{l , i , f}^{( 1 )} = 1 ,$$

it is not reported
For the other polarization, reference amplitude

$${p}_{l , i , f}^{( 1 )}$$

is quantized to 4 bits
   The 4-bit amplitude alphabet is

$$\{ 1 , {( \frac{1}{2} )}^{\frac{1}{4}} , {( \frac{1}{4} )}^{\frac{1}{4}} , {( \frac{1}{8} )}^{\frac{1}{4}} , … , {( \frac{1}{{2}^{14}} )}^{\frac{1}{4}} \} .$$

$$For \{ {c}_{l , i , f} , ( i , f ) \neq ( {i}^{*} , {f}^{*} ) \} :$$

For each polarization, differential amplitudes

$${p}_{l , i , f}^{( 2 )}$$

relative to the associated polarization-specific reference amplitude and quantized to 3 bits
   The 3-bit amplitude alphabet is

$$\{ 1 , \frac{1}{\sqrt{2}} , \frac{1}{2} , \frac{1}{2 \sqrt{2}} , \frac{1}{4} , \frac{1}{4 \sqrt{2}} , \frac{1}{8} , \frac{1}{8 \sqrt{2}} \} .$$

Note: The final quantized amplitude p_{l,i,f} is given by

$${p}_{l , i , f}^{( 1 )} \times {p}_{l , i , f}^{( 2 )}$$

Each phase is quantized to either δPSK (Nₚₕ=8) or 16PSK (Nₚₕ=16) (which is configurable).

For the polarization r*∈{0, 1} associated with the strongest coefficient

$${c}_{l , {i}^{*} , {f}^{*}} , {r}^{*} = ⌊ \frac{{i}^{*}}{L} ⌋$$

and the reference amplitude

$${p}_{l , i , f}^{( 1 )} = {p}_{l , {r}^{*}}^{( 1 )} = 1.$$

For the other polarization

$$r ∈ \{ 0 , 1 \} and r \neq {r}^{*} , r = ( ⌊ \frac{{i}^{*}}{L} ⌋ + 1 ) mod 2$$

and the reference amplitude

$${p}_{l , i , f}^{( 1 )} = {p}_{l , r}^{( 1 )}$$

is quantized (reported) using the 4-bit amplitude codebook mentioned herein.

A UE can be configured to report M FD basis vectors. In one example,

$$M = ⌈ p \times \frac{{N}_{3}}{R} ⌉ ,$$

where R is higher-layer configured from {1,2} and p is higher-layer configured from

$$\{ \frac{1}{2} , \frac{1}{4} \} .$$

In one example, the p value is higher-layer configured for rank 1-2 CSI reporting. For rank >2 (e.g. rank 3-4), the p value (denoted by v₀) can be different. In one example, for rank 1-4, (p, v₀) is jointly configured from

$$\{ ( \frac{1}{2} , \frac{1}{4} ) , ( \frac{1}{4} , \frac{1}{4} ) , ( \frac{1}{4} , \frac{1}{8} ) \} , i . e . M = ⌈ p \times \frac{{N}_{3}}{R} ⌉$$

$$for rank 1 - 2 and M = ⌈ {v}_{0} \times \frac{{N}_{3}}{R} ⌉$$

for rank 3-4. In one example, N₃=N_{SB}×R where N_{SB} is the number of SBs for CQI reporting. In the rest of the disclosure, M is replaced with M_{υ} to show its dependence on the rank value υ, hence p is replaced with p_{υ}, υ∈{1,2} and v₀ is replaced with p_{υ}, υ∈{3,4}.

A UE can be configured to report My FD basis vectors in one-step from N₃ basis vectors freely (independently) for each layer l∈{1, . . . , υ} of a rank υ CSI reporting. Alternatively, a UE can be configured to report M_{υ} FD basis vectors in two-step as follows.
In step 1, an intermediate set (InS) comprising

$${N}_{3}^{′} < {N}_{3}$$

basis vectors is selected/reported,
In step 2, for each layer l∈{1, . . . , υ} of a rank u CSI reporting, My FD basis vectors are selected/reported freely (independently) from N′₃ basis vectors in the InS.

In one example, one-step method is used when N_{3≤19} and two-step method is used when N₃>19. In one example,

$${N}_{3}^{′} = ⌈ α {M}_{υ} ⌉ where α > 1$$

is either fixed (to 2 for example) or configurable.

The codebook parameters used in the DFT based frequency domain compression (eq. 5) are (i, p_{υ} for υ ∈{1,2}, p_{υ} for υ∈{3,4}, β, α, Nₚₕ). In one example, the set of values for these codebook parameters are as follows.
L: the set of values is {2,4} in general, except L∈{2, 4, 6} for rank 1-2, 32 CSI-RS antenna ports, and R=1.

$$( {p}_{υ} for υ ∈ \{ 1 , 2 \} , {p}_{υ} for υ ∈ \{ 3 , 4 \} ) ∈ \{ ( \frac{1}{2} , \frac{1}{4} ) , ( \frac{1}{4} , \frac{1}{4} ) , ( \frac{1}{4} , \frac{1}{8} ) \} .$$

$$β ∈ \{ \frac{1}{4} , \frac{1}{2} , \frac{3}{4} \} .$$

$$α = 2$$

$${N}_{p h} = 16 .$$

The set of values for these codebook parameters are as in Table 1.

TABLE 1

| | | p_{υ} | | |
|---|---|---|---|---|
| paramCombination-r17 | L | υ ∈ {1, 2} | υ ∈ {3, 4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

In Rel. 17 (further enhanced Type II port selecting codebook)

$$M ∈ \{ 1 , 2 \} , L = \frac{{K}_{1}}{2} where {K}_{1} = α \times {P}_{CSIRS} ,$$

and codebook parameters (M, α, β) are configured from Table 2.

TABLE 2

| paramCombination-r17 | M | α | β |
|---|---|---|---|
| 1 | 1 | ¾ | ½ |
| 2 | 1 | 1 | ½ |
| 3 | 1 | 1 | ¾ |
| 4 | 1 | 1 | 1 |
| 5 | 2 | ½ | ½ |
| 6 | 2 | ¾ | ½ |
| 7 | 2 | 1 | ½ |
| 8 | 2 | 1 | ¾ |

The framework (equation 5) mentioned herein represents the precoding-matrices for multiple (N₃) FD units using a linear combination (double sum) over 2L SD beams and My FD beams. This framework can also be used to represent the precoding-matrices in time domain (TD) by replacing the FD basis matrix W_{f} with a TD basis matrix Wₜ, wherein the columns of Wₜ comprises My TD beams that represent some form of delays or channel tap locations. Hence, a precoder W^{l} can be described as follows.

$$W = {A}_{l} {C}_{l} {B}_{l}^{H} = {W}_{1} {\tilde{W}}_{2} {W}_{t}^{H} , \qquad ( 5 A )$$

In one example, the Mᵥ TD beams (representing delays or channel tap locations) are selected from a set of N₃ TD beams, i.e., N₃ corresponds to the maximum number of TD units, where each TD unit corresponds to a delay or channel tap location. In one example, a TD beam corresponds to a single delay or channel tap location. In another example, a TD beam corresponds to multiple delays or channel tap locations. In another example, a TD beam corresponds to a combination of multiple delays or channel tap locations.

The rest of disclosure is applicable to both space-frequency (equation 5) and space-time (equation 5A) frameworks.

This disclosure focuses on a measuring a CS-RS burst that can be used to obtain time-domain (TD) or Doppler-domain (DD) component(s)/properties of the channel. The measured channel can be used to report time-domain channel property (TDCP) or delay domain (DD) components, either alone (separate) or together with the other CSI components (e.g. based on space-frequency compression).

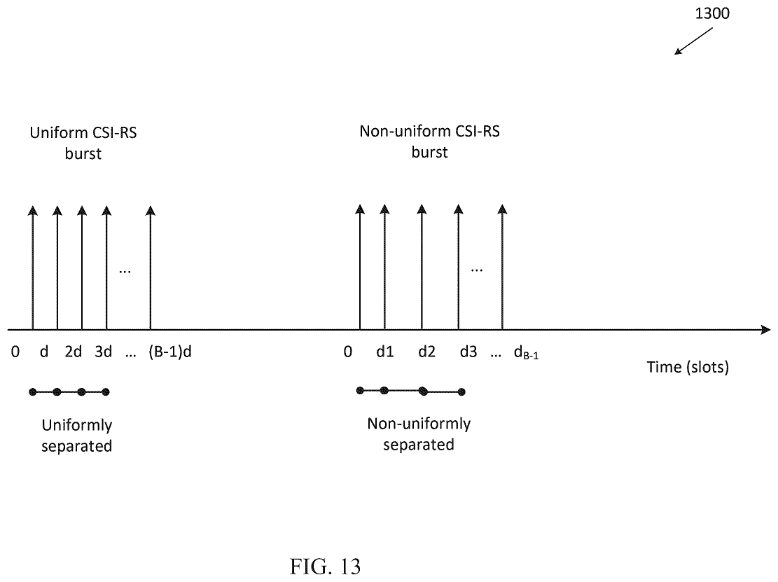

FIG. 13 illustrates an example of a timeline 1300 for a UE to receive NZP CSI-RS resource(s) bursts according to embodiments of the present disclosure. For example, timeline 1300 can be followed by any of the UEs 111-116 of FIG. 1, such as the UE 113. This example is for illustration only and other embodiments can be used without departing from the scope of the present disclosure.

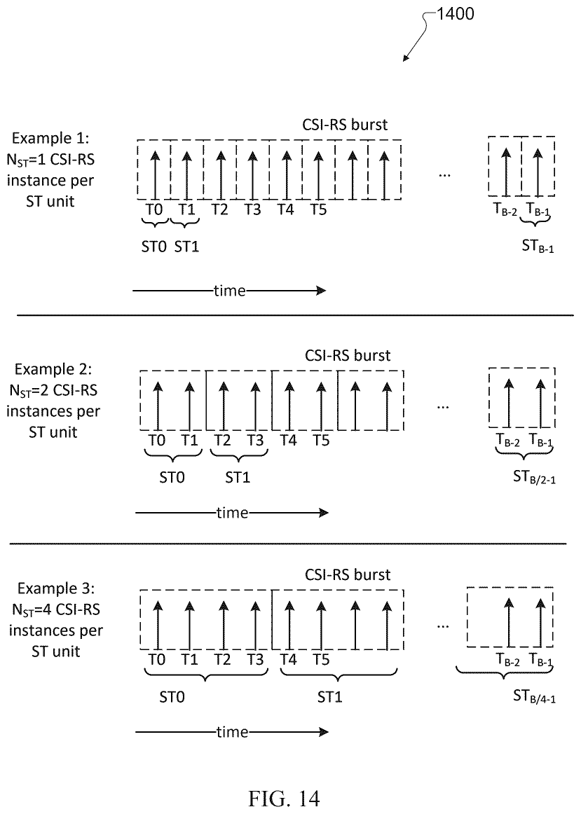

FIG. 14 illustrates examples of timelines 1400 for partitioned CSI-RS burst instances according to embodiments of the present disclosure. For example, timelines 1400 can be followed by any of the UEs 111-116 of FIG. 1, such as the UE 114. This example is for illustration only and other embodiments can be used without departing from the scope of the present disclosure.

In one embodiment, as shown in FIG. 13, a UE is configured to receive a burst of non-zero power (NZP) CSI-RS resource(s), referred to as CSI-RS burst for brevity, in B time slots, where B≥1. The B time slots can be according to at least one of the following examples.
In one example, the B time slots are evenly/uniformly spaced with an inter-slot spacing d.
In one example, the B time slots can be non-uniformly spaced with inter-slot spacing e₁=d₁, e₂=d₂−d₁, e₃=d₃−d₂, . . . , so on, where eᵢ≠eⱼ for at least one pair (i, j) with i≠j.

The UE receives the CSI-RS burst, estimates the B instances of the DL channel measurements, and uses the channel estimates to obtain the Doppler component(s) of the DL channel. The CSI-RS burst can be linked to (or associated with) a single CSI reporting setting (e.g. via higher layer parameter CSI-ReportConfig), wherein the corresponding CSI report includes an information about the Doppler component(s) of the DL channel.

Let hₜ be the DL channel estimate based on the CSI-RS resource(s) received in time slot t∈{0, 1, . . . , B−1}. When the DL channel estimate in slot t is a matrix Gₜ of size N_{RX}×N_{TX}×N_{SC}, then hₜ=vec(Gₜ), where N_{RX}, N_{TX}, and N_{SC} are number of receive (Rx) antennae at the UE, number of CSI-RS ports measured by the UE, and number of subcarriers in frequency band of the CSI-RS burst, respectively. The notation vec(X) is used to denote the vectorization operation wherein the matrix X is transformed into a vector by concatenating the elements of the matrix in an order, for example, 1→2→3→ and so on, implying that the concatenation starts from the first dimension, then moves to the second dimension, and continues until the last dimension. Let H_{B}=[h₀ h₁ . . . h_{B-1}] be a concatenated DL channel. The Doppler component(s) of the DL channel can be obtained based on H_{B}. For example, H_{B} can be represented as

$$C {Φ}^{H} = {\sum }_{s = 0}^{N - 1} {c}_{s} {ϕ}_{s}^{H} where Φ = [ \begin{matrix}{ϕ}_{0} & {ϕ}_{1} & … & {ϕ}_{N - 1}\end{matrix} ]$$

is a Doppler domain (DD) basis matrix whose columns comprise basis vectors, C=[c₀ c₁ . . . . C_{N-1}] is a coefficient matrix whose columns comprise coefficient vectors, and N<B is the number of DD basis vectors. Since the columns of H_{B} are likely to be correlated, a DD compression can be achieved when the value of N is small (compared to the value of B). In this example, the Doppler component(s) of the channel is represented by the DD basis matrix $ and the coefficient matrix C.

Additional details of the CSI-RS bursts can be as described in to U.S. patent application Ser. No. 17/689,838 filed Mar. 8, 2022 (the '838 application), which is incorporated by reference herein in its entirety.

Let N₄ be the length of the basis vectors {φₛ}, e.g., each basis vector is a length N₄×1 column vector.

In one embodiment, for SDCP or spatial domain component reporting (or a CSI reporting that includes SDCP or spatial domain components), a UE (e.g., the UE 116) is configured to receive a CSI reporting setting (e.g. via higher layer CSI-ReportConfig) that is linked to a CSI resource setting (e.g. via higher layer CSI-ResourceConfig), and includes the higher layer parameter reportQuantity set to other than ‘none’ (or set to a new quantity such as ‘sdcp’ or other name), where the CSI resource setting includes at least one of the following examples: In one example, the CSI resource setting includes NZP CSI-RS resource set(s) for ‘tracking’. In one example, the CSI resource setting includes NZP CSI-RS resource set(s) for ‘CSI.’ In one example, the CSI resource setting includes NZP CSI-RS resource(s) for ‘tracking’ (i.e. with higher layer trs-info). In one example, the CSI resource setting includes NZP CSI-RS resource(s) for ‘CSI’ (i.e. without higher layer trs-info).

In one embodiment, the CSI resource setting includes NZP CSI-RS resource set(s) for ‘CSI’, and CSI-RS ports for the NZP CSI-RS resource set can be according to at least one of the following examples. Alternatively, the CSI resource setting includes NZP CSI-RS resource(s) for ‘CSI’, and CSI-RS ports for the NZP CSI-RS resource(s) can be according to at least one of the following examples.

In one example, a fixed number (e.g. one or two) of CSI-RS ports is allowed to be configured for SDCP measurement.

In one example, X CSI-RS ports can be configured for SDCP measurement, where X is a configurable value (implicitly or explicitly) that does not exceed M, which is a maximum value for P_{CSIRS} for SDCP, i.e., X≤M. For example, M=2, 4, 8, 12, 16, 24, 32, 48, 64, 128, or more than 128 e.g., 256, 512.

In one example, 2N₁N₂ CSI-RS ports can be configured for SDCP measurement, where N₁ and N₂ are numbers of CSI-RS ports (with the same polarization/group index) for a first antenna-port dimension and a second antenna-port dimension, respectively, and 2 is a number of polarizations/groups.

In one example, N₁N₂ CSI-RS ports can be configured for SDCP measurement, where N₁ and N₂ are numbers of CSI-RS ports for a first antenna-port dimension and a second antenna-port dimension, respectively.

In one example, N₁+N₂ CSI-RS ports can be configured for SDCP measurement, where N₁ and N₂ are numbers of CSI-RS ports for a first antenna-port dimension and a second antenna-port dimension, respectively.

In one example, 2(N₁+N₂) CSI-RS ports can be configured for SDCP measurement, where N₁ and N₂ are numbers of CSI-RS ports (with the same polarization/group index) for a first antenna-port dimension and a second antenna-port dimension, respectively, and 2 is a number of polarizations/groups.

For example, the supported values of N₁ and N₂ for SDCP measurement are the same as the supported pairs of (N₁, N₂) for CSI reporting (i.e., up to 128 ports in Rel-19 CSI enhancement).

For example, the supported values of N₁ and N₂ for SDCP measurement include at least one of the supported pairs of (N₁, N₂) for CSI reporting (i.e., up to 128 ports in Rel-19 CSI enhancement).

In one example, P_{CSIRS} CSI-RS ports can be configured for measuring SDCP measurement, where the supported value of P_{CSIRS} for SDCP includes all of or at least a subset of 1, 2, 4, 6, 8, 12, 16, 24, 32, 48, 64, and 128.

When CSI-RS is for ‘tracking’ (i.e. with higher layer trs-info), the number of CSI-RS ports is fixed to 1 or 2.

In one embodiment, a UE is configured to determine/report a CSI report, where the CSI report includes SDCP or spatial domain component(s) of the channel. Such a configuration can be via higher layer CSI-ReportConfig including reportQuantity set to ‘new quantity’ or ‘sdcp’ (or other name), where ‘new quantity’ or ‘sdcp’ corresponds to at least one of the following.

In one example, SDCP is a spatial-domain correlation across antenna ports. In one example, a correlation between a channel coefficient for a first antenna port and another channel coefficient for a second antenna port is determined/reported. In one example, the two antenna ports have the same polarization or group index. In one example, the two antenna ports have the same or different polarization or group index. In one example, the two antenna ports correspond to the same CSI-RS resource or resource set. In one example, the two antenna ports correspond to the same or different CSI-RS resource or resource set.

In one example, the correlation can be determined in a form of absolute value (i.e., not relative to a value or port). In one example, the reported SDCP quantity corresponds to (associated with) ports.

In one example, the correlation can be determined in a form of relative value with respect to a reference value (or port). In one example, the reported SDCP quantity corresponds to (associated with) ports except the reference port. The reference port can be fixed (e.g. lowest index) or reported by the UE (as part of CSI report) or configured (via higher layer or DCI).

In one example, when SDCP is determined for two antenna ports, e.g., the channel coefficient vector with size 2 corresponds to h=[h₁ h₂], the SDCP can be determined as h₁ and conj(h₁)·h₂, and the quantization values for h₁ and conj(h₁)·h₂ are reported via indicator(s). In this disclosure, conj(x) refers to the conjugate of x. In one example, the indicator(s) indicate a phase value. In one example, the indicator(s) indicate an amplitude value. In one example, the indicator(s) indicate both phase and amplitude values.

For phase value(s), it is quantized using a 2^{X}-PSK (phase shift-keying) alphabet set, where X is payload size (bits).

For amplitude value(s), it is quantized using an alphabet set which includes points in [0,1].

When CSI-RS density ρ=1 (i.e. 1 RE per RB port), hᵢ=[h_{1,i}, h_{2,i}] corresponds to RB i. Then, SDCP can be defined as c=τ_{i∈B} cᵢ where cᵢ=conj(h_{1,i})·h_{2,i} and B=set of RBs in CSI reporting band (or measurement band).

When CSI-RS density ρ>1 (e.g. 3), h_{1,m}=[h_{1,i,m}, h_{2,i,m}] corresponds to RB i and RE m. Then SDCP can be defined as c=Σ_{ieB,m∈R} c_{i,m} where c_{i,m}=conj(h_{1,i,m})·h_{2,i,m} and B=set of RBs in CSI reporting band (or measurement band) and R=set of REs in each RB.

When CSI-RS density ρ<1 (e.g. 0.5), hᵢ=[h_{1,i}, h_{2,i}] corresponds to RB i that contains CSI-RS RE. Then, SDCP can be defined as c=Σ_{i∈B} cᵢ where cᵢ=conj(h_{1,i})·h_{2,i} and B=set of RBs in CSI reporting band (or measurement band) that contain CSI-RS RE.

In one example, when SDCP is determined for two antenna ports, e.g., the channel coefficient vector with size 2 corresponds to h=[h₁ h₂], a reference value is fixed, e.g., the first channel coefficient (a.w. the first antenna port index) is normalized to 1, and the other channel coefficient is also normalized by the first channel coefficient and the correlation is determined. Examples can be as follows:

When CSI-RS density ρ=1 (i.e. 1 RE per RB port), hᵢ=[h_{1,i}, h_{2,i}] corresponds to RB i. Then, SDCP can be defined as

$$c = \frac{{\sum }_{i ∈ B} {c}_{i}}{{( {\sum }_{i ∈ B} {\vert {h}_{1 , i} \vert}^{2} )}^{1 / 2}} where {c}_{i} = conj ( {h}_{1 , i} ) \cdot {h}_{2 , i} and$$

$$B = set of RBs in CSI reporting band ( or measurement band ) .$$

When CSI-RS density ρ>1 (e.g. 3), h_{i,m}=[h_{1,i,m}, h_{2,i,m}] corresponds to RB i and RE m. Then SDCP can be defined as

$$c = {\sum }_{i ∈ B , m ∈ R} \frac{{c}_{i m}}{{( {\sum }_{i ∈ B , m ∈ R} {\vert {h}_{1 , i , m} \vert}^{2} )}^{1 / 2}} where {c}_{i , m} = conj ( {h}_{1 , i , m} ) \cdot {h}_{2 , i , m} and$$

$$B = set of RBs in CSI reporting band ( or measurement band )$$

and R=set of REs in each RB.

When CSI-RS density ρ<1 (e.g. 0.5), hᵢ=[h_{1,i}, h_{2,i}] corresponds to RB i that contains CSI-RS RE. Then, SDCP can be defined as

$$c = \frac{{\sum }_{i ∈ B} {c}_{i}}{{( {\sum }_{i ∈ B} {\vert {h}_{1 , i} \vert}^{2} )}^{1 / 2}} where {c}_{i} = conj ( {h}_{1 , i} ) \cdot {h}_{2 , i} and$$

$$B = set of RBs in CSI reporting band ( or measurement band )$$

that contain CSI-RS RE.

In one example, when SDCP is determined for two antenna ports, e.g., the channel coefficient vector with size 2 corresponds to h=[h₁ h₂], a reference value is determined by the UE and reported the location of the reference value via an indicator with size of 1-bit. In one example, the strongest value is determined as a reference value. The reference channel coefficient is normalized to 1, and the other channel coefficient is also normalized by the reference channel coefficient and the correlation is determined. Examples can be as follows.

When CSI-RS density ρ=1 (i.e. 1 RE per RB port), hᵢ=[h_{1,i}, h_{2,i}] corresponds to RB i. Then, SDCP can be defined as

$$c = \frac{{\sum }_{i ∈ B} {c}_{i}}{{( {\sum }_{i ∈ B} {\vert {h}_{1 , i} \vert}^{2} )}^{1 / 2}} where {c}_{i} = conj ( {h}_{1 , i} ) \cdot {h}_{2 , i} and$$

$$B = set of RBs in CSI reporting band ( or measurement band ) ,$$

and R=set if REs in each RB, where x is the reference index, and y≠x.

When CSI-RS density ρ>1 (e.g. 3), h_{i,m}=[h_{1,i,m}, h_{2,i,m}] corresponds to RB i and RE m. Then SDCP can be defined as

$$c = {\sum }_{i ∈ B , m ∈ R} \frac{{c}_{i m}}{{( {\sum }_{i ∈ B , m ∈ R} {\vert {h}_{x , i , m} \vert}^{2} )}^{1 / 2}} where {c}_{i , m} = conj ( {h}_{x , i , m} ) \cdot {h}_{y , i , m} and$$

$$B = set of RBs in CSI reporting band ( or measurement band )$$

and R=set of REs in each RB, where x is the reference index, and y≠x.

When CSI-RS density ρ<1 (e.g. 0.5), hᵢ=[h_{1,i}, h_{2,i}] corresponds to RB i that contains CSI-RS RE. Then, SDCP can be defined as

$$c = \frac{{\sum }_{i ∈ B} {c}_{i}}{{( {\sum }_{i ∈ B} {\vert {h}_{x , i} \vert}^{2} )}^{1 / 2}} where {c}_{i} = conj ( {h}_{x , i} ) \cdot {h}_{y , i} and$$

$$B = set of RBs in CSI reporting band ( or measurement band )$$

that contain CSI-RS RE, where x is the reference index, and y≠x.

In one example, when SDCP is determined for P antenna ports, e.g., the channel coefficient vector with size P corresponds to h=[h₁ h₂ . . . h_{P}], the SDCP can be determined as h₁, conj(h₁)·h₂, conj(h₁)·h₃, . . . , conj(h₁)·h_{P}, and the quantization values for h₁ and conj(h₁)*hⱼ for j=2, . . . , P are reported via indicator(s). In general, the SDCP can be determined as hᵢ, conj(hᵢ)·hⱼ for j≠i, and reported.

When CSI-RS density ρ=1 (i.e. 1 RE per RB port), hᵢ=[h₁, h_{2,i} . . . h_{P,i}], corresponds to RB i. Then, SDCP can be defined as cⱼ=Σ_{i∈B} c_{i,j} where c_{i,j}=conj(h_{1,i})·h_{j,i} for j≠1 and B=set of RBs in CSI reporting band (or measurement band).

When CSI-RS density ρ>1 (e.g. 3), h_{i,m}=[h_{1,i,m} h_{2,i,m} . . . h_{P,i,m}], corresponds to RB i and RE m. Then SDCP can be defined as cⱼ=Σ_{i∈B,mER} c_{i,m,j} where c_{i,m,j}=conj(h_{1,i,m})·h_{j,i,m} for j≠1 and B=set of RBs in CSI reporting band (or measurement band) and R=set of REs in each RB.

When CSI-RS density ρ<1 (i.e. 0.5), hᵢ=[h₁, h_{2,i} . . . h_{P,i}], corresponds to RB i that contains CSI-RS RE. Then, SDCP can be defined as cⱼ=Σ_{i∈B} c_{i,j} where c_{i,j}=conj(h_{1,i})·h_{j,i} for j≠1 and B=set of RBs in CSI reporting band (or measurement band) that contain CSI-RS RE.

In one example, when SDCP is determined for P antenna ports, e.g., the channel coefficient vector with size P corresponds to h=[h₁ h₂ . . . h_{P}], a reference value is fixed, e.g., the first channel coefficient (a.w. the first antenna port index) is normalized to 1, and the other channel coefficients are also normalized by the first channel coefficient and the correlation values are determined. That is,

$$conj ( {h}_{1} ) * \frac{{h}_{j}}{\vert {h}_{1} \vert} for j \neq 1$$

are computed and quantized and reported. Since the reference value is 1, it is not reported. Examples can be as follows.

When CSI-RS density ρ=1 (i.e. 1 RE per RB port), hᵢ=[h_{1,i}, h_{2,i} . . . h_{P,i}], corresponds to RB i. Then, SDCP can be defined as

$${c}_{j} = \frac{{\sum }_{i ∈ B} {c}_{i , j}}{{( {\sum }_{i ∈ B} {\vert {h}_{1 , i} \vert}^{2} )}^{1 / 2}} where {c}_{i , j} = conj ( {h}_{1 , i} ) \cdot {h}_{j , i} for j \neq 1 and$$

$$B = set of RBs in CSI reporting band ( or measurement band ) .$$

When CSI-RS density ρ>1 (e.g. 3), h_{i,m}=[h_{1,i,m} h_{2,i,m} . . . h_{P,i,m}], corresponds to RB i and RE m. Then SDCP can be defined as

$${c}_{j} = \frac{{\sum }_{i ∈ B , m ∈ R} {c}_{i , m , j}}{{( {\sum }_{i ∈ B , m ∈ R} {\vert {h}_{1 , i , m} \vert}^{2} )}^{1 / 2}} where {c}_{i , m , j} = conj ( {h}_{1 , i , m} ) \cdot {h}_{j , i , m} for j \neq 1 and$$

$$B = set of RBs in CSI reporting band ( or measurement band )$$

and R=set of REs in each RB.

When CSI-RS density ρ<1 (i.e. 0.5), hᵢ=[h₁, h_{2,i} . . . h_{P,i}], corresponds to RB i that contains CSI-RS RE. Then, SDCP can be defined as

$${c}_{j} = \frac{{\sum }_{i ∈ B} {c}_{i , j}}{{( {\sum }_{i ∈ B} {\vert {h}_{1 , i} \vert}^{2} )}^{1 / 2}} where {c}_{i , j} = conj ( {h}_{1 , i} ) \cdot {h}_{j , i} for j \neq 1 and$$

$$B = set of RBs in CSI reporting band ( or measurement band )$$

that contain CSI-RS RE.

In one example, when SDCP is determined for two antenna ports, e.g., the channel coefficient vector with size P corresponds to h=[h₁ h₂ . . . h_{P}], a reference value is determined by the UE and reported the location of the reference value via an indicator with size of ┌log 2 P┐ bits. In one example, the strongest value is determined as a reference value. The reference channel coefficient is normalized to 1, and the other channel coefficients are also normalized by the reference channel coefficient and the correlation values are determined. That is,

$$conj ( {h}_{r} ) * \frac{{h}_{j}}{\vert {h}_{r} \vert} \vert j \neq 1$$

and computed and quantized and reported, where hr is determined as the reference value. Since the reference value is 1, it is not reported. Examples can be as follows.

When CSI-RS density ρ=1 (i.e. 1 RE per RB port), hᵢ=[h_{1,i}, h_{2,i} . . . h_{P,i}], corresponds to RB i. Then, SDCP can be defined as

$${c}_{j} = \frac{{\sum }_{i ∈ B} {c}_{i , j}}{{( {\sum }_{i ∈ B} {\vert {h}_{r , i} \vert}^{2} )}^{1 / 2}} where {c}_{i , j} = conj ( {h}_{r , i} ) \cdot {h}_{j , i} for j \neq 1 and$$

$$B = set of RBs in CSI reporting band ( or measurement band ) .$$

When CSI-RS density ρ>1 (e.g. 3), h_{i,m}=[h_{1,i,m} h_{2,i,m} . . . h_{P,i,m}], corresponds to RB i and RE m. Then SDCP can be defined as

$${c}_{j} = \frac{{\sum }_{i ∈ B , m ∈ R} {c}_{i , m , j}}{{( {\sum }_{i ∈ B , m ∈ R} {\vert {h}_{r , i , m} \vert}^{2} )}^{1 / 2}} where {c}_{i , m , j} = conj ( {h}_{r , i , m} ) \cdot {h}_{j , i , m} for j \neq 1 and$$

$$B = set of RBs in CSI reporting band ( or measurement band )$$

and R=set of REs in each RB.

When CSI-RS density ρ<1 (i.e. 0.5), hᵢ=[h_{1,i}, h_{2,i} . . . h_{P,i}], corresponds to RB i that contains CSI-RS RE. Then, SDCP can be defined as

$${c}_{j} = \frac{{\sum }_{i ∈ B} {c}_{ij}}{{( {\sum }_{i ∈ B} {\vert {h}_{r , i} \vert}^{2} )}^{1 / 2}} where {c}_{i , j} = conj ( {h}_{r , i} ) \cdot {h}_{j , i} for$$

$$j \neq 1 and B = set of RBs in CSI reporting band ( or measurement band )$$

that contain CSI-RS RE.

In one example, when SDCP is determined for N₁+N₂ antenna ports, e.g., the channel coefficient vector with size N₁ corresponds to h=[h₁ h₂ . . . h_{N1}] and the channel coefficient vector with size N₂ corresponds to g=[g₁ g₂ . . . g_{N2}], the SDCP can be determined as h₁, conj(h₁)*h₂, conj(h₁)*h₃, . . . , conj(h₁)*h_{N1}, and g₁, conj(g₁)*g₂, conj(g₁)*g₃, . . . , conj(g₁)*g_{N2}, and the quantization values for h₁ and conj(h₁)*hⱼ for j=2, . . . , N₁ and for gᵢ and conj(g₁)*gⱼ for j=2, . . . , N₂ are reported via indicator(s). In general, the SDCP can be determined as hᵢ, conj(hᵢ)*hⱼ for j≠i, and gᵢ, conj(gᵢ)*gⱼ for j≠i, and they are reported after quantization.

Similar to the examples herein, the example can be extended for different CSI-RS density cases and with/without reference index (fixed or reported or configured).

In one example, SDCP includes a correlation measure among (sub-) channel vectors or a distance measure among (sub-) channel vectors.

In one example, a cosine similarity can be a correlation measure among channel vectors, which can be according to at least one of the following forms:

$$c = \frac{{h}^{H} g}{‖ h ‖ \cdot ‖ g ‖} ,$$

where h, g are (sub-) channel vectors.

$$c = \frac{{h}^{H} g}{{‖ h ‖}^{2}} ,$$

where h, g are (sub-) channel vectors.

In one example, c has two components: amplitude value and phase value. They are quantized and selected respective alphabet sets. In one example, only amplitude value(s) is quantized and reported via an indicator. In one example, only phase value(s) is quantized and reported via an indicator. In one example, both amplitude value(s) and phase value(s) are quantized and reported via respective indicators.

For each phase value of the correlation measure, it is quantized using a 2^{X}-PSK (phase shift-keying) alphabet set, where X is payload size (bits).

For each amplitude value of the correlation measure, it is quantized using an alphabet set which includes points in [0,1].

In one example, sub-channel vector hᵢⱼ for a channel vector h with size P₁ can be defined as

$$h = [ \begin{matrix}{h}_{1} \\ ⋮ \\ {h}_{{M}_{1}}\end{matrix} ]$$

where h_{i,j} is a sub-channel vector with size P₁/M₁.

In one example, P₁=N₁. In another example, P₁=N₂

In one example, cᵢⱼ for ∇j≠i are determined and reported, where

$${c}_{ij} = \frac{{h}_{i}^{H} {h}_{j}}{‖ {h}_{i} ‖ \cdot ‖ {h}_{j} ‖} or {c}_{ij} = \frac{{h}_{i}^{H} {h}_{j}}{{‖ {h}_{i} ‖}^{2}} .$$

Here, a reference index i can be fixed, (e.g., lowest index). In another example, a reference index i can be determined by UE and reported via an indicator of size ┌log₂ M₁┐ bits.

In one example, cᵢⱼ for ∇j, i are determined and reported, where

$${c}_{ij} = \frac{{h}_{i}^{H} {h}_{j}}{‖ {h}_{i} ‖ \cdot ‖ {h}_{j} ‖} or {c}_{ij} = \frac{{h}_{i}^{H} {h}_{j}}{{‖ {h}_{i} ‖}^{2}} .$$

Here, there is not a reference index and pairs of cᵢⱼ are quantized and reported.

In one example, sub-channel vector hᵢⱼ for a channel vector h with size P₁ can be defined as

$$h = [ \begin{matrix}{h}_{1} \\ ⋮ \\ {h}_{{M}_{1}}\end{matrix} ]$$

where h_{i,j} is a sub-channel vector with size P₁/M₁, and sub-channel vector gᵢⱼ for a channel vector g with size P₂ can be defined as

$$g = [ \begin{matrix}{g}_{1} \\ ⋮ \\ {g}_{{M}_{2}}\end{matrix} ]$$

where g_{i,j} is a sub-channel vector with size P₂/M₂

In one example, (P₁, P₂)=(N₁, N₂).

In one example, cᵢⱼ for ∇j≠i are determined and reported, where

$${c}_{ij} = \frac{{h}_{i}^{H} {h}_{j}}{‖ {h}_{i} ‖ \cdot ‖ {h}_{j} ‖} or {c}_{ij} = \frac{{h}_{i}^{H} {h}_{j}}{{‖ {h}_{i} ‖}^{2}} .$$

Here, a reference index i can be fixed, (e.g., lowest index). In another example, a reference index i can be determined by UE and reported via an indicator of size ┌log₂ M₁┐ bits.

In one example, dᵢⱼ for ∇j≠i are determined and reported, where

$${d}_{ij} = \frac{{g}_{i}^{H} {g}_{j}}{‖ {g}_{i} ‖ \cdot ‖ {g}_{j} ‖} or {d}_{ij} = \frac{{g}_{i}^{H} {g}_{j}}{{‖ {g}_{i} ‖}^{2}} .$$

Here, a reference index i can be fixed, (e.g., lowest index). In another example, a reference index i can be determined by UE and reported via an indicator of size ┌log₂ M₂┐ bits.

In one example, cᵢⱼ for ∇j,i are determined and reported, where

$${c}_{ij} = \frac{{h}_{i}^{H} {h}_{j}}{‖ {h}_{i} ‖ \cdot ‖ {h}_{j} ‖} or {c}_{ij} = \frac{{h}_{i}^{H} {h}_{j}}{{‖ {h}_{i} ‖}^{2}} .$$

Here, there is not a reference index and pairs of cᵢⱼ are quantized and reported.

In one example, dᵢⱼ for ∇j,i are determined and reported, where

$${d}_{ij} = \frac{{g}_{i}^{H} {g}_{j}}{‖ {g}_{i} ‖ \cdot ‖ {g}_{j} ‖} or {d}_{ij} = \frac{{g}_{i}^{H} {g}_{j}}{{‖ {g}_{i} ‖}^{2}} .$$

Here, there is not a reference index and pairs of dᵢⱼ are quantized and reported.

In one example, sub-channel vector hᵢⱼ for a channel matrix H with size N₁×N₂ (or N₂×N₁) can be defined as

$$H = [ \begin{matrix}{h}_{1 , 1} & … & {h}_{1 , {N}_{2}} \\ ⋮ & ⋱ & ⋮ \\ {h}_{{M}_{1} , 1} & … & {h}_{{M}_{1} , {N}_{2}}\end{matrix} ]$$

where h_{i,j} is a sub-channel vector with size N₁/M₁. The channel matrix H can be vectorized as

$$vec ( H ) = [ \begin{matrix}{h}_{1 , 1} \\ ⋮ \\ {h}_{{M}_{1} , 1} \\ ⋮ \\ {h}_{{M}_{1} , {N}_{2}}\end{matrix} ] = [ \begin{matrix}{h}_{1} \\ ⋮ \\ {h}_{{M}_{1} {N}_{2}}\end{matrix} ]$$

where the total number of sub-channel vectors is M₁×N₂ (or M₂×N₁), and thus it is reindexed as shown herein.

In one example, cᵢⱼ for ∇j≠i are determined and reported, where

$${c}_{ij} = \frac{{h}_{i}^{H} {h}_{j}}{‖ {h}_{i} ‖ \cdot ‖ {h}_{j} ‖} or {c}_{ij} = \frac{{h}_{i}^{H} {h}_{j}}{{‖ {h}_{i} ‖}^{2}} .$$

Here, a reference index i can be fixed, (e.g., lowest index). In another example, a reference index i can be determined by UE (e.g., the UE 116) and reported via an indicator of size ┌log₂ M₁N₂┐ bits (or ┌log₂ M₂N₁┐ bits.

Similar to the examples herein, the example can be extended for different CSI-RS density cases and with/without reference index (fixed or reported or configured).

The content of the CSI report (including SDCP or spatial-domain component reporting) configured via reportQuantity set to other than ‘none’, as described herein, is configured according to at least one of the following embodiments.

In one embodiment, reportQuantity set to other than ‘none’ corresponds to a separate report.

In one example, reportQuantity=‘new quantity’ or ‘SDCP’, where the new quantity is according to (corresponds to) at least one of the examples described herein.

The time-domain behavior for such reporting can be configured according to at least one of the following examples.
In one example, the TD behavior is fixed to periodic (P).
In one example, the TD behavior is fixed to semi-persistent on PUCCH (SPonPUCCH).
In one example, the TD behavior is fixed to semi-persistent on PUSCH (SPonPUSCH).
In one example, the TD behavior is fixed to aperiodic (AP).
In one example, the TD behavior is configured from {P, SPonPUCCH}.
In one example, the TD behavior is configured from {P, SPonPUSCH}.
In one example, the TD behavior is configured from {P, AP}.
In one example, the TD behavior is configured from {AP, SPonPUCCH}.
In one example, the TD behavior is configured from {AP, SPonPUSCH}.
In one example, the TD behavior is configured from {SPonPUCCH, SPonPUCCH}.
In one example, the TD behavior is configured from {P, SPonPUCCH, SPonPUCCH}.
In one example, the TD behavior is configured from {AP, SPonPUCCH, SPonPUCCH}.
In one example, the TD behavior is configured from {P, AP, SPonPUCCH}.
In one example, the TD behavior is configured from {P, AP, SPonPUSCH}.
In one example, the TD behavior is configured from {P, SPonPUCCH, SPonPUCCH, SP}.

When configured, the TD behavior of the CSI-ReportConfig is indicated by the higher layer parameter reportConfigType.

In one embodiment, the CSI reporting for SDCP or spatial-domain component can be triggered or configured to perform via DCI (or MAC-CE or RRC signaling).

In one embodiment, the CSI reporting for SDCP or spatial-domain component can be UE-initiated to request or to perform via UCI or MAC-CE.

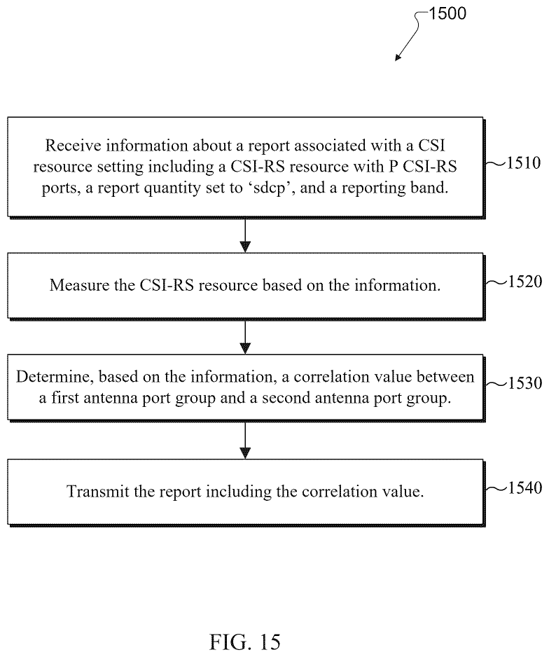

FIG. 15 illustrates an example method 1500 performed by a UE in a wireless communication system according to embodiments of the present disclosure. The method 1500 of FIG. 15 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1500 is for illustration only and other embodiments can be used without departing from the scope of the present disclosure.

The method 1500 begins with the UE receiving information about a report associated with a CSI resource setting including a CSI-RS resource with P CSI-RS ports, a report quantity set to ‘sdcp’, and a reporting band (1510). The UE then measures the CSI-RS resource based on the information (1520).

The UE then determines, based on the information, a correlation value between a first antenna port group and a second antenna port group (1530). For example, in 1530, the correlation value is normalized by at least one of norm values of the first antenna port group and second antenna port group over the reporting band. The first antenna port group corresponds to a first subset of the P CSI-RS ports. The second antenna port group corresponds to a second subset of the P CSI-RS ports.

In various embodiments, the correlation value is decomposed into a phase value and an amplitude value, and the phase value and the amplitude value are selected from respective alphabet sets. In some examples, the phase value is selected from a X-phase shift keying (X-PSK) alphabet set, where X=2ⁿ and n is a number of bits and the amplitude value is selected from an alphabet set including points in [0,1].

In various embodiments, the first subset corresponds to channel vector h_{i,k} of port group i, the second subset correspond to channel vector h_{j,k} of port group j for a frequency resource k, and the correlation value is defined based on

$$c = \frac{{\sum }_{k ∈ B} {h}_{i , k}^{H} {h}_{j , k}}{{( {\sum }_{k ∈ B} {‖ {h}_{i , k} ‖}^{2} )}^{\frac{1}{2}} {( {\sum }_{k ∈ B} {‖ {h}_{j , k} ‖}^{2} )}^{\frac{1}{2}}} ,$$

where B is the reporting band.

In various embodiments, the first subset corresponds to channel vector h_{i,k} of port group i, the second subset correspond to channel vector h_{j,k} of port group j for a frequency resource k, and the correlation value is defined based on

$$c = \frac{{\sum }_{k ∈ B} {h}_{i , k}^{H} {h}_{j , k}}{( {\sum }_{k ∈ B} {‖ {h}_{i , k} ‖}^{2} )} ,$$

where B is the reporting band.

In various embodiments, the first subset corresponds to channel vector h_{i,k} of port group i, the second subset correspond to channel vector h_{i+Δ,k} of port group i+Δ for a frequency resource k, where Δ>0 is a value of antenna spacing between the two port groups, and the correlation value is defined based on

$${c}_{Δ} = \frac{{\sum }_{k ∈ B} {h}_{i , k}^{H} {h}_{i + Δ , k}}{{( {\sum }_{k ∈ B} {‖ {h}_{i , k} ‖}^{2} )}^{\frac{1}{2}} {( {\sum }_{k ∈ B} {‖ {h}_{i + Δ , k} ‖}^{2} )}^{\frac{1}{2}}} ,$$

where B is the reporting band.

The UE then transmits the report including the correlation value (1540). In various embodiments, the UE includes a reference indicator in the report and the reference indicator indicates port group i.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive information about a report associated with a channel state information (CSI) resource setting including (i) a CSI reference-signal (CSI-RS) resource with P CSI-RS ports, (ii) a report quantity set to ‘sdcp’, and (iii) a reporting band; and
a processor operably coupled to the transceiver, the processor, based on the information, configured to:
measure the CSI-RS resource, and
determine a correlation value between a first antenna port group and a second antenna port group, wherein:
the correlation value is normalized by at least one of norm values of the first antenna port group and second antenna port group over the reporting band,
the first antenna port group corresponds to a first subset of the P CSI-RS ports, and
the second antenna port group corresponds to a second subset of the P CSI-RS ports,
wherein the transceiver is further configured to transmit the report including the correlation value.

2. The UE of claim 1, wherein:
the correlation value is decomposed into a phase value and an amplitude value, and
the phase value and the amplitude value are selected from respective alphabet sets.

3. The UE of claim 2, wherein:
the phase value is selected from a X-phase shift keying (X-PSK) alphabet set, where X=2ⁿ and n is a number of bits, and
the amplitude value is selected from an alphabet set including points in [0,1].

4. The UE of claim 1, wherein:
the first subset corresponds to channel vector h_{i,k} of port group i,
the second subset correspond to channel vector h_{j,k} of port group j for a frequency resource k, and
the correlation value is defined based on
$$c = \frac{{\sum }_{k ∈ B} {h}_{i , k}^{H} {h}_{j , k}}{{( {\sum }_{k ∈ B} {‖ {h}_{i , k} ‖}^{2} )}^{\frac{1}{2}} {( {\sum }_{k ∈ B} {‖ {h}_{j , k} ‖}^{2} )}^{\frac{1}{2}}} ,$$
where B is the reporting band.

5. The UE of claim 1, wherein:
the first subset corresponds to channel vector h_{i,k} of port group i,
the second subset correspond to channel vector h_{j,k} of port group j for a frequency resource k, and
the correlation value is defined based on
$$c = \frac{{\sum }_{k ∈ B} {h}_{i , k}^{H} {h}_{j , k}}{( {\sum }_{k ∈ B} {‖ {h}_{i , k} ‖}^{2} )} ,$$
where B is the reporting band.

6. The UE of claim 5, wherein:
the processor is further configured to include a reference indicator in the report, and
the reference indicator indicates port group i.

7. The UE of claim 1, wherein:
the first subset corresponds to channel vector h_{i,k} of port group i,
the second subset correspond to channel vector h_{1+Δ,k} of port group i+Δ for a frequency resource k, where Δ>0 is a value of antenna spacing between the two port groups, and
the correlation value is defined based on
$${c}_{Δ} = \frac{{\sum }_{k ∈ B} {h}_{i , k}^{H} {h}_{i + Δ , k}}{{( {\sum }_{k ∈ B} {‖ {h}_{i , k} ‖}^{2} )}^{\frac{1}{2}} {( {\sum }_{k ∈ B} {‖ {h}_{i + Δ , k} ‖}^{2} )}^{\frac{1}{2}}} ,$$
where B is the reporting band.

8. A base station (BS) comprising:
a processor; and
a transceiver operably coupled to the processor, the transceiver configured to:
transmit information about a report associated with a channel state information (CSI) resource setting including (i) a CSI reference-signal (CSI-RS) resource with P CSI-RS ports, (ii) a report quantity set to ‘sdcp’, and (iii) a reporting band; and
receive the report including a correlation value between a first antenna port group and a second antenna port group, wherein:
the correlation value is normalized by at least one of norm values of the first antenna port group and second antenna port group over the reporting band,
the first antenna port group corresponds to a first subset of the P CSI-RS ports, and
the second antenna port group corresponds to a second subset of the P CSI-RS ports.

9. The BS of claim 8, wherein:
the correlation value is decomposed into a phase value and an amplitude value, and
the phase value and the amplitude value are from respective alphabet sets.

10. The BS of claim 9, wherein:
the phase value is from a X-phase shift keying (X-PSK) alphabet set, where X=2ⁿ and n is a number of bits, and
the amplitude value is from an alphabet set including points in [0,1].

11. The BS of claim 8, wherein:
the first subset corresponds to channel vector h_{i,k} of port group i,
the second subset correspond to channel vector h_{j,k} of port group j for a frequency resource k, and
the correlation value is defined based on
$$c = \frac{{\sum }_{k ∈ B} {h}_{i , k}^{H} {h}_{j , k}}{{( {\sum }_{k ∈ B} {‖ {h}_{i , k} ‖}^{2} )}^{\frac{1}{2}} {( {\sum }_{k ∈ B} {‖ {h}_{j , k} ‖}^{2} )}^{\frac{1}{2}}} ,$$
where B is the reporting band.

12. The BS of claim 8, wherein:
the first subset corresponds to channel vector h_{i,k} of port group i,
the second subset correspond to channel vector h_{j,k} of port group j for a frequency resource k, and
the correlation value is defined based on
$$c = \frac{{\sum }_{k ∈ B} {h}_{i , k}^{H} {h}_{j , k}}{( {\sum }_{k ∈ B} {‖ {h}_{i , k} ‖}^{2} )} ,$$
where B is the reporting band.

13. The BS of claim 12, wherein:
the report includes a reference indicator, and
the reference indicator indicates port group i.

14. The BS of claim 8, wherein:
the first subset corresponds to channel vector h_{i,k} of port group i, the second subset correspond to channel vector h_{i+Δ,k} of port group i+Δ for a frequency resource k, where Δ>0 is a value of antenna spacing between the two port groups, and
the correlation value is defined based on
$${c}_{Δ} = \frac{{\sum }_{k ∈ B} {h}_{i , k}^{H} {h}_{i + Δ , k}}{{( {\sum }_{k ∈ B} {‖ {h}_{i , k} ‖}^{2} )}^{\frac{1}{2}} {( {\sum }_{k ∈ B} {‖ {h}_{i + Δ , k} ‖}^{2} )}^{\frac{1}{2}}} ,$$
where B is the reporting band.

15. A method performed by a user equipment (UE), the method comprising:
receiving information about a report associated with a channel state information (CSI) resource setting including (i) a CSI reference-signal (CSI-RS) resource with P CSI-RS ports, (ii) a report quantity set to ‘sdcp’, and (iii) a reporting band;
measuring the CSI-RS resource based on the information;
determining, based on the information, a correlation value between a first antenna port group and a second antenna port group, wherein:
the correlation value is normalized by at least one of norm values of the first antenna port group and second antenna port group over the reporting band,
the first antenna port group corresponds to a first subset of the P CSI-RS ports, and
the second antenna port group corresponds to a second subset of the P CSI-RS ports; and
transmitting the report including the correlation value.

16. The method of claim 15, wherein:
the correlation value is decomposed into a phase value and an amplitude value, and
the phase value and the amplitude value are selected from respective alphabet sets.

17. The method of claim 16, wherein:
the phase value is selected from a X-phase shift keying (X-PSK) alphabet set, where X=2ⁿ and n is a number of bits, and
the amplitude value is selected from an alphabet set including points in [0,1].

18. The method of claim 15, wherein:
the first subset corresponds to channel vector h_{i,k} of port group i,
the second subset correspond to channel vector h_{j,k} of port group j for a frequency resource k, and
the correlation value is defined based on
$$c = \frac{{\sum }_{k ∈ B} {h}_{i , k}^{H} {h}_{j , k}}{{( {\sum }_{k ∈ B} {‖ {h}_{i , k} ‖}^{2} )}^{\frac{1}{2}} {( {\sum }_{k ∈ B} {‖ {h}_{j , k} ‖}^{2} )}^{\frac{1}{2}}} ,$$
where B is the reporting band.

19. The method of claim 15, wherein:
the first subset corresponds to channel vector h_{i,k} of port group i,
the second subset correspond to channel vector h_{j,k} of port group j for a frequency resource k, and
the correlation value is defined based on
$$c = \frac{{\sum }_{k ∈ B} {h}_{i , k}^{H} {h}_{j , k}}{( {\sum }_{k ∈ B} {‖ {h}_{i , k} ‖}^{2} )} ,$$
where B is the reporting band.

20. The method of claim 19, further comprising:
including a reference indicator in the report,
wherein the reference indicator indicates port group i.
